(19) United States
(12) Patent Application Publication
(10) Pub. No.: US 2006/0026549 A1
(43) Pub. Date: Feb. 2, 2006

(54) Method and system for conducting an online transaction of multi-project wafer service

(75) Inventors: Piao-Chuo Tsao, Bade City (TW); Shu-Ling Feng, Hsinchu City (TW); Yi-Hong Tseng, Hsin-Chu City (TW)

Correspondence Address: HAYNES AND BOONE, LLP, 901 MAIN STREET, SUITE 3100, DALLAS, TX, 75202, US

(73) Assignee: Taiwan Semiconductor Manufacturing Company, Ltd., Hsin-Chu (TW)

(21) Appl. No.: 10/899,564

(22) Filed: Jul. 27, 2004

(51) Int. Cl. G06F 17/50; G06F 19/00; G06F 17/00

(52) U.S. Cl. 716/19; 700/121; 705/500; 706/921

(57) ABSTRACT

An online multi-project wafer method comprises providing, via an online interface, a template, receiving, via the online interface, at least two sets of completed templates each having information descriptive of an integrated circuit, checking the received at least two sets of completed templates, providing feedback for respective ones of the at least two sets of completed templates, and integrating the information associated with the integrated circuits into one common mask set.

### RELATED APPLICATION

This patent application is related to a commonly-assigned US patent application entitled “Systems and Method for Customized Tape-Out Requests for Integrated Circuit Manufacturing”, filed on May 11, 2004 Ser. No. ______ (Attorney Docket. TSMC 2003-0646/24061.98).

### BACKGROUND

The semiconductor integrated circuit (IC) industry has experienced rapid growth. Technological advances in IC materials and design have produced generations of ICs where each generation has smaller and more complex circuits than the previous generation. However, these advances have increased the complexity of processing and manufacturing ICs and, for these advances to be realized, similar developments in IC processing and manufacturing have been needed.

Furthermore, as the IC industry has matured, the various operations needed to produce an IC may be performed at different locations by a single company or by different companies that specialize in a particular area. This further increases the complexity of producing ICs, as companies and their customers may be separated not only geographically, but also by time zones, making effective communication more difficult. For example, a first company (e.g., an IC design house) may design a new IC, a second company (e.g., an IC foundry) may provide the processing facilities used to fabricate the design, and a third company may assemble and test the fabricated IC. A fourth company may handle the overall manufacturing of the IC, including coordination of the design, processing, assembly, and testing operations.

Whether in the context of a single facility or multiple facilities, communication issues may present problems in a number of areas, such as in the fabrication of IC's designed by a customer. For example, in IC manufacturing processes that use a photomask (or “mask”) to create such devices as application specific integrated circuits (ASICs) or multi project wafers (MPWs), the mask design generally involves communication between customers and mask manufacturing facilities. The process of preparing and finalizing mask design information for an IC (e.g., mask design tape-out) generally involves both customers ordering the IC and engineers from the manufacturing facility. The customer may provide tape-out information to a manufacturing facility using a number of different formats. This introduces additional complexity into the tape-out process, as engineers from the manufacturing facility may need to manually check the data provided by the customer and communicate with the customer regarding aspects of the tape-out information that are unclear or incorrect. More than that, in a multi project wafers transaction, customers may dynamically request a job and/or drop a job, may have different priority, and different requirement. Non-efficiency in communication, synchronization, and coordination may cause confliction/error, prolong cycle time, increase manufacturing cost, and add too much inconvenience to customers.

### BRIEF DESCRIPTION OF THE DRAWINGS

FIG. 1 is a simplified block diagram of an embodiment of a system for providing multi-project semiconductor device manufacturing with an online customer interface.

FIG. 2 is a simplified block diagram of a virtual IC fabrication system that can benefit from the disclosed manufacturing system.

FIG. 3 is a flow diagram of an embodiment of a method for providing multiple project limited semiconductor device manufacturing.

FIG. 4 is a flow diagram of an embodiment of the online customer interface system employed in the disclosed method and system.

FIGS. 5a and 5b are planar views of a semiconductor photomask and wafer, respectively, illustrating the implementation of a multiple project wafer.

FIG. 6 illustrates an embodiment of an online screen interface by which a customer may interact with the job request component of the disclosed system.

### DETAILED DESCRIPTION

The present disclosure relates generally to the field of semiconductor manufacturing and, more particularly, to a system and method for online multi-project semiconductor device integration. It is understood, however, that the following disclosure provides many different embodiments, or examples, for implementing different features of the disclosure. Specific examples of components and arrangements are described below to simplify the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various embodiments and/or configurations discussed.

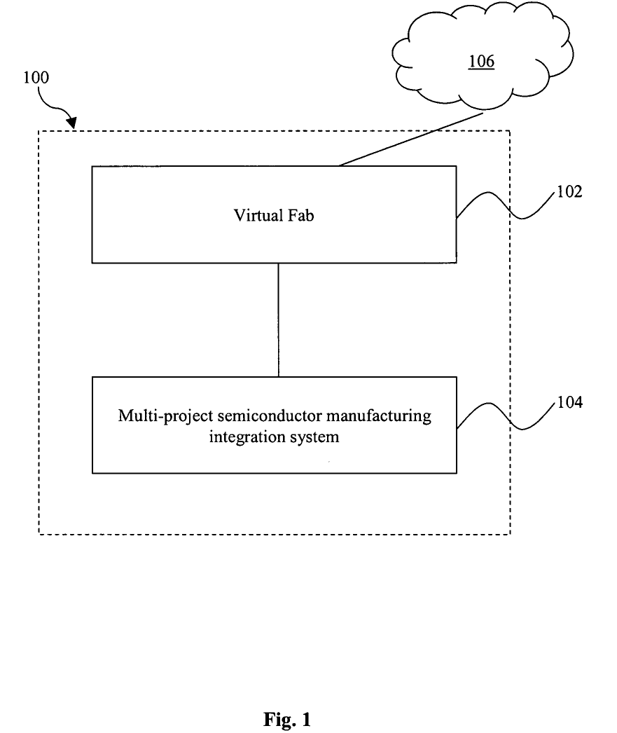

FIG. 1 is a system 100 for providing online multi-project semiconductor device integration in one embodiment. The system 100 may include at least two components 102 and 104. Component 102 represents an integrated virtual IC fabrication system (a “virtual fab”). Component 104 represents a multi-project semiconductor manufacturing integration system. The multi-project semiconductor manufacturing integration system 104 may include all inter-fab mask process flows and information services for either internal or external customers. The multi-project semiconductor manufacturing integration system 104 may provide a vehicle across all embodiments of the integrated virtual fab 102 by which a plurality of customers each may initiate a plurality of job requests, track, and receive a semiconductor device fabricated upon limited real estate of a semiconductor substrate via an online interface.

The multi-project semiconductor manufacturing integration system 104 may employ the use of multiple project wafers (multi-project wafers or MPW). Multi-project wafers are wafers wherein a plurality of different semiconductor integrated circuits (IC's) may be fabricated upon the limited real estate of the same wafer. The multiple project wafer may include a plurality of different devices from a same customer or different customers. The multiple project wafer method of component 104 may utilize a singular lithographic mask or mask set. Therefore, multiple customers or companies may share in the cost of a mask set.

Virtual fab 102 further comprises an online customer interface for job request communication and monitoring. The online customer interface provides an interface to a customer or plurality thereof for creating, confirming, and tracking a job request from the beginning to the end of the fabrication process. The job request may include a plurality of other job requests from different customers, wherein the plurality of job requests may be merged to form a parent job request. The parent job request allows for the customers to share the cost of mask and wafer fabrication wherein the plurality of different devices may be integrated into one mask set and may be fabricated upon a wafer by using the same mask set. The virtual fab 102 may be coupled to a communications network 106 to provide an online customer interface. Through the communication network, the customers may provide specifications on a job, receive data, receive feedback, and track the manufacturing progress without restrictions as to geography and time zones.

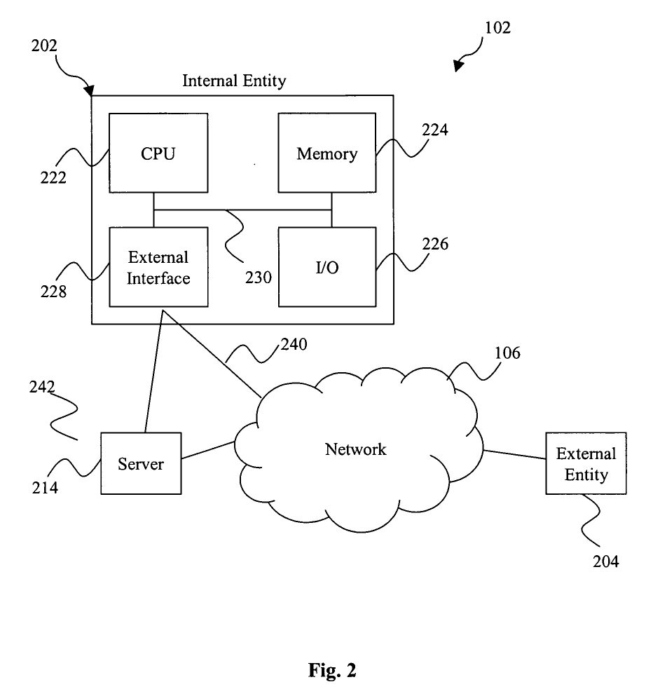

FIG. 2 is one embodiment of the virtual fab 102 in which a multiple project wafer manufacturing may be implemented. The virtual fab 102 may include a plurality of entities, represented by one or more internal entities 202 and one or more external entities 204 that are coupled by a communications network 106. The network 106 may be a single network or may be a variety of different networks, such as an intranet and the Internet, and may include both wireline and wireless communication channels.

Each of the entities 202, 204 may include one or more computing devices such as servers, personal computers, personal digital assistants, pagers, cellular telephones, and the like. For example, the internal entity 202 is expanded to show a central processing unit (CPU) 222, a memory unit 224, an input/output (I/O) device 226, and an external interface 228. The external interface may be, for example, a modem, a wireless transceiver, and/or one or more network interface cards (NICs). The components 222-228 are interconnected by a bus system 230. It is understood that the internal entity 202 may be configured in a number of different ways and that each of the listed components may actually represent several components. For example, the CPU 222 may actually represent a multi-processor or a distributed processing system; the memory unit 224 may include different data storage or memory devices such as cache memory, main memory, hard disks, and remote memory storage devices; and the I/O device 226 may include monitors, keyboards, and the like.

The internal entity 202 may be connected a network 106 through a wireless or wired link 240, and/or through an intermediate network 242, which may be further connected to the communications network. Intermediate network 242 may be, for example, a complete network or a subnet of a local area network, a company wide intranet, and/or the Internet. Intermediate network 242 may include a server 214 in one embodiment. The internal entity 202 may be identified on one or both of the networks 214, 242 by an address or a combination of addresses, such as a media control access (MAC) address associated with the network interface 228 and an internet protocol (IP) address. Because the internal entity 202 may be connected to the intermediate network 242, certain components may, at times, be shared with other internal entities. Therefore, a wide range of flexibility is anticipated in the configuration of the internal entity 202. Furthermore, it is understood that, in some implementations, server 214 may be provided to support multiple internal entities 202. In other implementations, a combination of one or more servers and computers may together represent a single entity.

In the present example, the internal entities 202 represent those entities that are directly responsible for producing the end product, such as a set of masks, a wafer, or individually tested IC devices. On the other hand, examples of internal entities 202 include an engineer, customer service personnel, an automated system process, a design or fabrication facility and fab-related facilities such as raw-materials, shipping, assembly or test. Examples of external entities 204 include a customer, a design provider; and other facilities that are not directly associated or under the control of the fab. In addition, additional fabs and/or virtual fabs can be included with the internal or external entities. Each entity may interact with other entities and may provide services to and/or receive services from the other entities. The term entity as used herein includes a computer, terminal, or other device through which the user communicates with the system.

It is understood that the entities 202-204 may be concentrated at a single location or may be distributed, and that some entities may be incorporated into other entities. In addition, each entity 202, 204 may be associated with system identification information that allows access to information within the system to be controlled based upon authority levels associated with each entity's identification information.

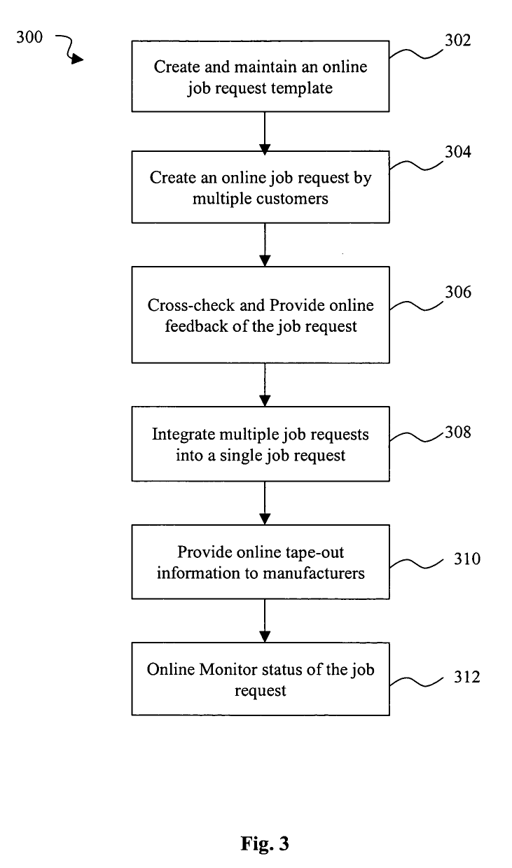

FIG. 3 illustrates an embodiment of an integrated method 300 for providing multiple project semiconductor device integration. The method 300 begins at step 302 wherein a job request template may be created and maintained by a multi-project semiconductor manufacturing integration system (integration system) and an associated semiconductor foundry. The semiconductor foundry may include a semiconductor manufacturer that has the capability to produce advanced complex photomasks and/or semiconductor wafers. The integration system may provide customers a plurality of online templates including product device order, mask tooling information, specific technology information, crosschecking format, and notification forms. The templates may be in a number of formats selectable by the user. The templates may be stored in a plurality of databases which may be accessed through the network 106 and/or through the virtual fab 102. The databases may include device specifications, mask tooling information, process capabilities, and any other tool that may be necessary to maintain a job request template. In one example, the job request template may contain a set of check rules to automatically check customer input information for validation. The job request template may be automated and may utilize tools and databases across the network 106 and the virtual fab 102 wherein specific operations may be automated. The job request template may be customized according to customer order for efficiency and convenience. For example, a customer may be asked to provide initial information when the customer put a MPW order. A customized MPW order template such as a mask tooling template may be provided to customer. A set of check rules may also be customized according to customer's initial order information and the semiconductor foundry technology databases.

Next at step 304, a single job request may be created from a plurality of customers' plurality of online job requests. The customers can initiate a job request using the online job request templates. The online job request templates may provide automated calculations or may provide automatic retrieval of information through the network 106 that may be filled into a specific job request of a customer. The customers may provide information such as window size (physical dimension of an area in a mask reserved for the customer's device), device configurations, device specifications, device design database, and order quantity.

Next at step 306, the integration system may cross-check and verify customer order information for its accuracy and validation, via the online interface, after the information from a customer is entered into a job request. This cross-checking and feedback to the customers may be performed substantially immediately after the job request has been submitted by the customer. A design circuit database may be first uploaded by a customer to a server coupled to the Internet or another suitable computer network. The customer provides the property and location of the design circuit database as a part of the MPW order information or mask tooling information. The integration system then downloads the design circuit database according to the customer's MPW order information or mask tooling information. Relevant information may be extracted from the design circuit database and compared with the customer' MPW order information or mask tooling information. For example, the comparison may compare mask layer information, the name of the design circuit file, the window size, and data type. Any inconsistence and errors according to the comparison will be provided, via the online interface, to the customer for correction and modification. The customer may respond to the comparison result by modifying the mask tooling information provided via the online interface to the integration system. The customer may receive the database check result via email or some other electronic means, for example. Step 306 may include a request for additional information and input from the customer and may alert the customer of any other issues associated with the current job request.

Next at 308, the integration system may integrate multiple job requests from a plurality of customers into a single job request. Each job request may be translated and integrated according to the mask tooling information, design circuit database, and the foundry databases. The multiple job requests from different customers are further integrated into a single parent job request wherein the plurality of customer job requests, whether online or not, may be fabricated upon a limited real estate of a semiconductor wafer. For example, there may be a plurality of five customer devices to be manufactured through the job request, the five different devices may be implemented in one single set of photomasks and fabricated upon a single semiconductor wafer. The limited real estate may be distributed across a plurality of wafers wherein the distributed real estate for the five customers may be the identical distribution across a plurality of wafers or the distribution of the customers job requests may be different through a plurality of wafers. The tape-out information may be further sent to customers for confirmation, via the online interface, email, telephone, and/or other proper communications.

Next at 310, the mask design documents (or tape-out information) integrated from the plurality of job requests may be provided to mask manufacturing for mask fabrication. Further, the mask set may be provided to a semiconductor wafer manufacturing for multi-project wafer fabrication.

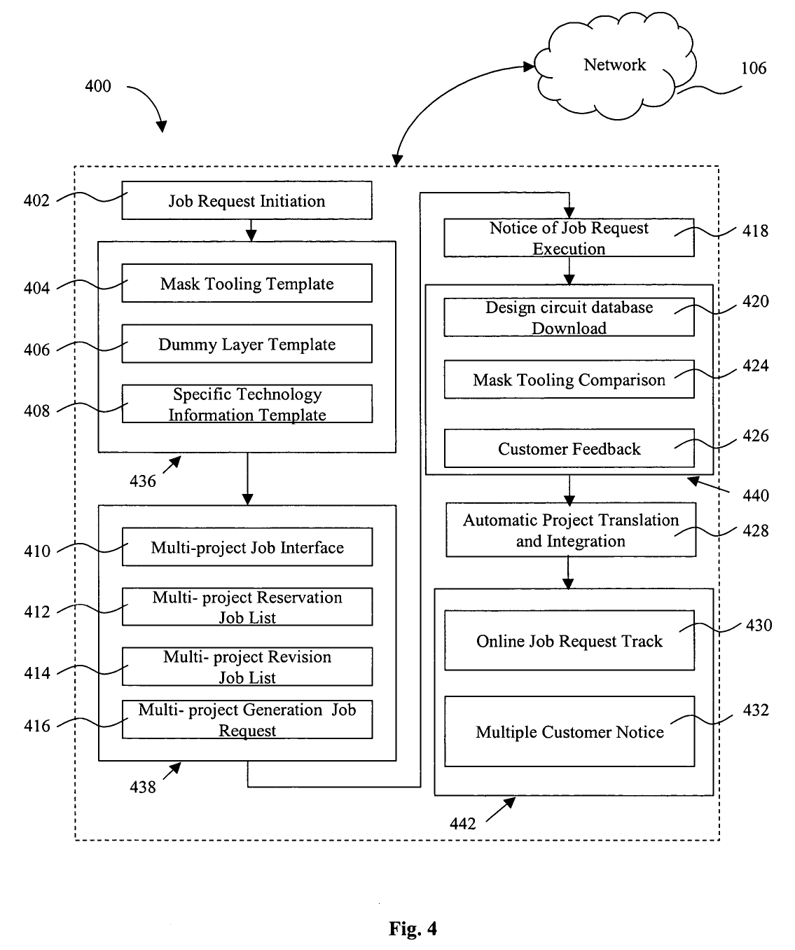

At step 312, each customer may have an access to monitor and track the status and progress of the associated job request(s) through various stages of the lifetime of a job request including multi-project integration, mask manufacturing, and wafer manufacturing. During the monitor and tracking, a customer may communicate with the integration system and/or the virtual fab, via the online interface, for update, report, feedback, and other related information. The customer may set up its own profile to request scheduled information. For example, the customer may request the integration system to provide job status through email when the integration, photomask fabrication, or wafer fabrication is completed. In another example, the customer may request the integration system to update job status every day. The online interface may be via a web browser application or another easy-to-use graphical interface. The customers can interface with the foundry through the network 106 of the virtual fab 102. The customers may monitor and modify the processing flow of the job request in real time. The customers may view status of the job request such as the time into and out of a process, current process, engineer comments, and any other information concerning the job request. The customers and foundry may change the job request process flow during the execution of the job request. In the case of changing the job request during execution by the customer, there may or may not have to be a consensus by other customers of the parent job flow to implement the change in the job flow during execution. The method of integrating multi-project wafer job requests may be further described and extended in description of the system 400 shown in FIG. 4.

FIG. 4 is a diagram of an embodiment of a system 400 for processing a job request. System 400 includes a plurality of modules which may mandate operation in a specific order; however the modules of system 400 are not limited to the order in which they are illustrated. System 400 may begin at job request module 402 to initiate a job request. The job request module 402 may be initiated through the network 106 and/or the virtual fab 102 at a customer site or at a foundry site. Once the job request is initiated by module 402, an online template module 436 may be accessed and displayed by the customer. The online template module 436 may include a mask tooling template module 404, a dummy layer template module 406, and a specific technology information template 408 for example. The online mask tooling (MT) template module 404 may provide an interface for the customer to enter masking related information, such as a layer code, a mask layer name description, and/or logical operation. Such an MT template may be systematically built according to technology definitions (e.g., 0.13 μm or 0.18 μm node technology). In some embodiments, the MT template may be a superset of data, with the customer selecting options from or entering data into relevant portions of the template. In other embodiments, the masking information maintained in the MT template may be tailored to serve particular customer's requirements. Accordingly, some items in the MT template may have default values or multiple options for a particular technology. The customer may select information (if options are presented) or enter information for each item having no default information or for which the default information does not match the customer's needs for a particular application.

The dummy layer template module 406 may be a superset of data, with the customer selecting options from or entering data into relevant portions of the template. In other embodiments, the dummy layer template may be tailored to serve the particular customer's requirements. Accordingly, some items in dummy layer template may have default values for a particular technology. The customer may enter information for each item not having default information or for which the default information does not match the customer's needs for a particular application.

The specific technology information (STI) template may be generated and/or loaded to provide one or more technology questions to be answered by the customer. The technology questions may be generated or loaded based on the initial information entered by the customer. As with the MT template, the STI template may be a superset of questions, with the customer answering only the relevant questions, or the STI template questions may be tailored to serve the particular customer's requirements. Answers to the STI questions may be used to customize the MT template. For example, STI may include a question such as “How many metal layers in the job request?”. The answer to the question may be customize the MT template to only include a number of metal layers as specified by the customer.

An online customer interface module 438 may provide customer an access to place and configure a job request over network 106. The online customer interface module 438 may include a plurality of sub-modules including a multi-project job interface 410, a multi-project reservation job list 412, a multi-project revision job list 414, and a multi-project generation job request 416. The customers may utilize the online multi-project job interface module 410 to put, configure, and manipulate information within the system 400. Thus when the term “multi-project” is used herein, each project may be from a different customers, or alternatively, the same customer when that customer desires multiple projects on the same wafer. The online multi-project reservation job list module 412 may include a system for generating a list of customer jobs and a reservation of a customer job which may be included in a specific job request for a multiple project wafer. The online multi-project reservation job list module 412 may categorize customer job requests according to technology, window size, order quantity, product shipping date, and compatibility. The module 412 may also provide a priority of customer job requests and may queue customer job requests according to categories, first-in-first-out (FIFO), or other specified priority ranking system which may be user-configurable. The online multi-customer revisions job list module 414 may include a list of customer amendments to job request and can include specific information illustrating where amendments occur and other information associated with any amendment by the system 400. The amendments to the list initiate an alert to any customer and the foundry which may include a wireless communication or an email through the network 106. A multi-customer generation job request module 416 may provide the generation of an online report of the customer job request and may provide generation of an organized customer job request after and during the fabrication of the job request by the system 400. The generation job list may initiate an alert to any customer and the foundry which may include an email, a voice mail, a page or another form of communication through the network 106. The embodiments of the customer interface module 438 as an aggregate can provide a real-time dynamic interface to the customers and the foundry and can interact with any other modules of the system 400 and the network 106.

Following the initiation of the multiple customer job request utilizing the online template module 436 and online customer interface module 438, a plurality of customer job requests may be selected to form a parent job request. A notice of job request execution 418 may provide an alert of the initiation of a parent job request including the number of customer devices and information regarding the status of the device fabrication. The notice of job request execution module 418 can initiate an alert to any customer and the foundry which may include any form of communication to the customer via the network 106.

Next, an online verification module 440 may verify the selected job requests for their validation and accuracy. The online verification module 420 may further include a design circuit database download sub-module 420 to download an associated design circuit database from an Internet server according to the customer-provided mask tooling information. The customer mask tooling information may provide the property and location of the design circuit database. The associated design circuit database may be uploaded to the Internet server by the customer when placing the job request. The design circuit database download sub-module 426 may track, in real-time, the location of circuit design database that may be utilized in the customer job request. The online verification module 440 may also include a mask tooling comparison sub-module 424. The mask tooling comparison sub-module 424 may extract relevant information from the associated design circuit database and compare to the mask tooling information or tape-out information for any inconsistency and errors. The online verification module 440 may also include a customer feedback sub-module 426. The customer feedback sub-module 426 may send comparison results, including inconsistency and errors, to the customer for correction and modification. The customer feedback sub-module 426 may raise a flag for the relevant job request if there is any inconsistency and error. The job request may be put on hold until the customer revision is received and incorporated. The customer feedback sub-module 426 also functions to receive the customer's revision and modification. Such verification processing may be repeated for each of the selected job requests through the online verification module 440. The database check and customer notification of the results may be performed as soon as the customer submits the job request and associated information. The database check result may be available substantially immediately after the job request has been submitted.

Next, the automatic project translation and integration module 428 may translate and integrate different job requests from different customers into information operable to fabricate one set of masks (tape-out information). The automatic project translation and integration module 428 may provide final components and information necessary for the enablement of the parent job request. The tape-out information may be further sent to each customer for confirmation. After confirmation of each job request from the associated customer, the tape-out information may be sent to mask fab for mask fabrication.

Next, a multi-project monitor module 442 enable a customer to monitor and modify the job request through the life time of the job request including multi-project integration, mask fabrication, and wafer fabrication stages. The multi-project monitor module 442 may include an online job request track sub-module 430. The customer may track the status of the job request using the online job request track sub-module 430. The customer may dynamically monitor the progress of the job request. For example, the customer may hold or modify the job request under certain circumstance. The customer may have dual-way communication with the semiconductor foundry. For example, the customer may set up to request relevant information in predefined schedule. For example, the customer may request updating the status of the job request every day. In another example, the customer may request to be updated of the completion of every processing stage through the job request lifetime.

The multi-project monitor module 442 may further include a multiple customer notice sub-module 432. The multiple customer notice sub-module 432 may send relevant information to contact points for each job request. The relevant information may be sent to the customer in customer preferred method including email, fax, or online customized interface. The relevant information may be a change notice, progress report, manufacturing update such as yield information. The customers may be notified of an amendment including mask tooling information after automatic project translation, and process recipes necessary for the job request. The multiple customer notice sub-module 432 may include alerting notification.

The customers can review the confirmation notification and any further modifications. The customers may approve the job request through multiple project monitor module 442. The multiple project wafer may utilize limited real estate for each customer. Alternatively, the job request may be implemented on a plurality of semiconductor wafers wherein each customer job request may be fabricated upon the entire semiconductor wafer and plurality thereof.

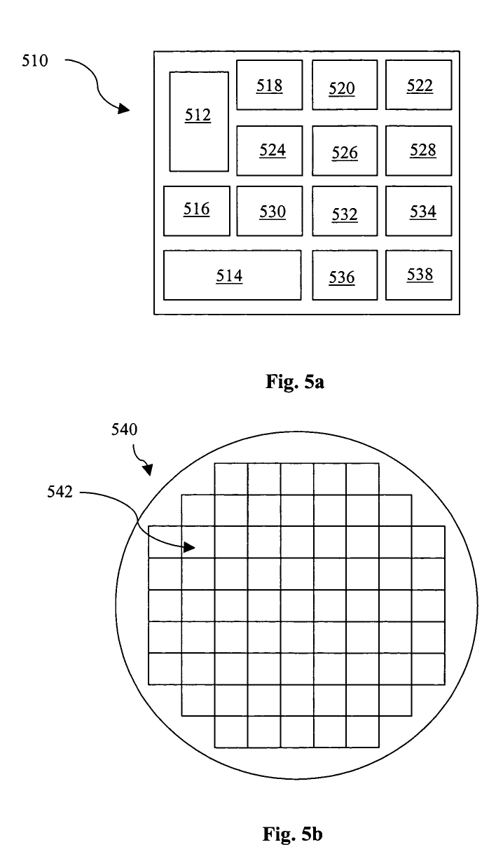

FIGS. 5a and 5b are planar views of a semiconductor mask and wafer, respectively, illustrating the implementation of a multiple project wafer. The mask 510 may be one layer of a set of masks to implement multiple-project semiconductor devices. For example, a pattern 512 may be designed for one job request and assigned to the proper location of the mask with requested window size and. A pattern 514 may be designed for another job request and assigned the current location with requested window size. More job requests such as 416 through 438 are illustrated and each of them is designed according to each of the job requests information and is assigned to a proper location of the mask.

FIG. 5b is a planar view of a multi-project semiconductor wafer 540. The multi-project semiconductor wafer 540 may be of any diameter and is partitioned into a plurality of semiconductor blocks 504. Each block 504 may include multiple semiconductor devices (or die) from different job requests. Each block 504 may be a map of the mask 510 (or a set of masks) and is formed through semiconductor manufacturing processing using the mask 510 (or the set of masks including the mask 510). Multiple job requests of electronic devices are integrated into one set of photomasks and multi-project wafers are manufactured accordingly. Thus the cost of photomask fabrication is shared by multiple job requests and the cost of each job request is reduced.

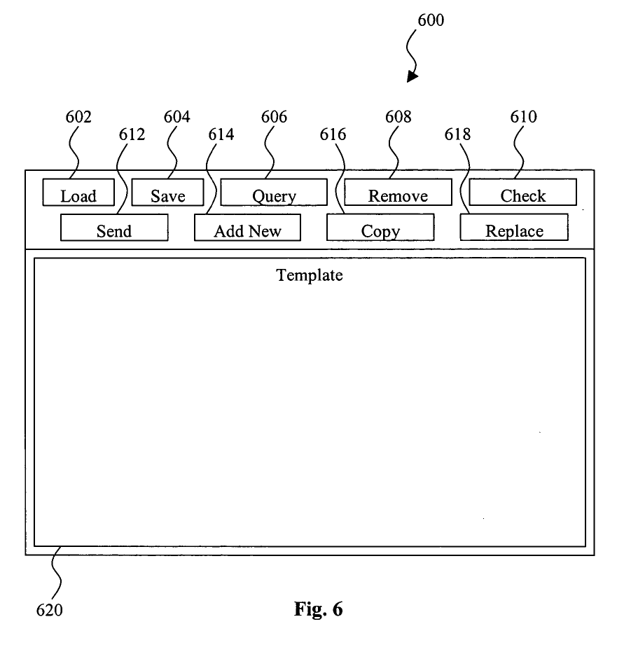

FIG. 6 is an online interface 600 illustrating one means by which a customer may interact with the job request system 400 of FIG. 4. It is understood that a variety of interface screens may be presented to a customer, including a login interface screen and a help interface screen that provides the customer with instructions on how to accomplish various tasks. After the customer logins to the job request system 400, the online interface 600 presents the customer with several options. In the present example, the online interface 600 includes a plurality of graphical elements such as a Load button 602, a Save button 604, an Query button 606, a Remove button 608, a Check button 610, an Send button 612, a Add New button 614, a Copy button 616, and a Replace button 618. The online interface 600 may also include a template 620 that provides the customer with a job request configuration and tape-out. The template 620 may be updated by job request specification during the design process to ensure that the job request is correct. Alternatively, the job request system specification may be applied to the template 620 after the configuration of the job request is completed. The template 620 may further represent a browser screen, a plurality of selection screens, and a real-time job request tracking screens.

The Load and Save buttons 602, 604 provide the customer with the option to either load a job request data and information built-in from the foundry database and customer tape-in or save a job request to the job request system 400 through the network 106. The Query button 606 may search for foundry device information, mask design, and other technical specification databases. The Remove button 608 enables the customer to remove a component or information from the job request, while the Check button 610 enables the system 400 to check the customer input data and design with foundry built-in designs and technical information. For example, activating the Check button 612 may be used for initiating module 426 of the job request system 400. The Check button 610 can be automated were user interface may not be required.

The Send button 612 may be used to send and receive email notifications from the job request system 400, while the Add New button 614 may enable the customer to add or edit and component to the job request. The Copy button 616 may enable the customer to duplicate an existing components or an existing component in the database of the network 106 (e.g., device component, device design rules, etc.). The Replace button 618 may enable a selected component to be replaced by another component. It is understood that the buttons and functions are illustrative, and that many other buttons and functions may be provided. For example, a context sensitive menu may be activated by clicking on a mouse button (not shown) or by using a keyboard (not shown). Accordingly, the interface 600 may be altered as desired to extend its functionality and to maximize customer support.

The online interface to virtual fab 103 may comprise one or more servers operable to couple to the Internet, for example. The servers may include a web server, a File Transfer Protocol (FTP) Server, an email server, etc. One or more data storage devices or servers may also be used. The online interface provide timely interactions and communication between the customers and the foundry or manufacturing facility. The communication channels are no longer restricted by time zone and geographical differences.

The current disclosure provide a method and system to conduct an online transaction of multi-project wafer service. The present disclosure has been described relative to a preferred embodiment. Improvements or modifications that become apparent to persons of ordinary skill in the art only after reading this disclosure are deemed within the spirit and scope of the application. It is understood that several modifications, changes and substitutions are intended in the foregoing disclosure and in some instances some features of the disclosure will be employed without a corresponding use of other features. Accordingly, it is appropriate that the appended claims be construed broadly and in a manner consistent with the scope of the disclosure.

What is claimed is:

1. An online multi-project wafer method comprising:
providing, via an online interface, a template;
receiving, via the online interface, at least two sets of completed templates each having information descriptive of an integrated circuit;
checking the received at least two sets of completed templates;
providing feedback for respective ones of the at least two sets of completed templates; and
integrating the information associated with the integrated circuits into one common mask set.

2. The method of claim 1 further comprising providing, via the online interface, status information associated with integrating and fabricating the first and second integrated circuits.

3. The method of claim 1 wherein the completed template comprises mask tooling information.

4. The method of claim 1 wherein the completed template comprises information associated with a circuit design database, and the method further comprises accessing the circuit design database for a circuit file associated with the integrated circuit.

5. The method of claim 1 wherein the completed template comprises location information associated with a circuit design database and a name of a circuit file, and the method further comprises accessing the circuit design database for the circuit file associated with the integrated circuit.

6. The method of claim 4 where checking the received at least two sets of completed templates comprises comparing the completed template and the respective circuit file.

7. The method of claim 6 comprising providing feedback regarding a difference between the completed template and the respective circuit file.

8. The method of claim 6 wherein providing feedback comprises providing a fail or success indication of a comparison between the completed template and the circuit file.

9. The method of claim 7 wherein providing feedback comprises sending an email notification.

10. The method of claim 7 wherein providing feedback comprises providing a notification via the online interface.

11. The method of claim 1 wherein providing a template comprises providing templates of a plurality of formats.

12. The method of claim 1 further comprising receiving, via the online interface, a revised completed template in response to the feedback.

13. The method of claim 1 further comprising providing a graphical user interface.

14. The method of claim 1 wherein receiving completed templates comprises receiving complete templates related to a plurality of integrated circuits.

15. The method of claim 1 further comprising providing, via the online interface, a final confirmation on feedback associated with checking the templates.

16. An online semiconductor fabrication integration system comprising:
an online template accessible by a plurality of users for providing information descriptive of integrated circuits;
an online multi-project wafer interface operable to receive completed templates having information descriptive of a plurality of integrated circuits associated with a plurality of projects;
an online verification module operable to check the completed templates and provide feedback thereof; and
a monitoring module operable to provide online status of integrating the integrated circuits into one common mask set.

17. The system of claim 16 wherein the completed templates comprises mask tooling information.

20. The system of claim 16 wherein the online verification module is operable to compare a circuit file with information in the completed template.

21. The system of claim 16, wherein the online verification module is operable to download a circuit file using information in the completed template.

22. The system of claim 16 the online verification module is operable to compare information in the completed template with data in a circuit file and sending a notification in response to a result of the comparison.

23. The system of claim 16 the online verification module is operable to compare a information in the completed template with data in a circuit file as soon as the completed online template is received, and sending a notification of a difference detected in the completed template and the circuit file.

24. The system of claim 16 wherein the completed template comprises mask layer, structure name, window size, and data type.

25. A method comprising:
uploading a design circuit database to an internet server;
receiving an electronic mask tooling template having information related to an integrated circuit;
downloading a circuit file from the design circuit database;
cross-checking information between the electronic mask tooling template and the circuit file; and
providing immediate electronic feedback notification of a result of the cross-checking.

26. The method of claim 25 wherein the mask tooling template comprises properties and location of the design circuit database.

27. The method of claim 25 wherein cross-checking information comprises detecting a difference between the mask tooling template and the circuit file.

28. The method of claim 25 wherein providing immediate electronic feedback notification comprises sending an email notification.

29. The method of claim 25 further comprising integrating the integrated circuit described by the electronic mask tooling template with other integrated circuits to create one common mask set for fabrication on a multi-project wafer.

30. A method of integrating at least two integrated circuit projects, comprising:
receiving an electronic mask tooling file for each of the at least two integrated circuit projects;
downloading a design circuit database associated with each electronic mask tooling file;
cross-checking between the electronic mask tooling file and the design circuit databases; and
forming tape-out information for a common mask set integrating the at least two integrated circuit projects.

31. The method of claim 30 further comprising:
receiving confirmation from clients of the tape-out information; and
passing the tape-out information to a masking house.

32. The method of claim 30 wherein downloading a design circuit database comprises downloading the design circuit database from an Internet server.

33. The method of claim 31 wherein receiving confirmation from clients comprises receiving confirmation via the Internet.

34. The method of claim 30 wherein receiving an electronic mask tooling file comprises receiving a location of the design circuit database.
